(19) United States
(12) Patent Application Publication
(10) Pub. No.: US 2024/0246079 A1
(43) Pub. Date: Jul. 25, 2024

(54) Cassette Assembly

(71) Applicant: CellPath Ltd, Powys (GB)

(72) Inventors: Neil Dean Haine, Powys (GB); Nicholas Stephen Evans, Powys (GB); Richard John Titcombe, Powys (GB); Paul James Hatton Webber, Powys (GB); Philip Leslie John Webber, Powys (GB)

(21) Appl. No.: 18/100,328

(22) Filed: Jan. 23, 2023

(51) Int. Cl. B01L 3/00

(52) U.S. Cl. CPC B01L 3/50853

(57) ABSTRACT

A histology processing is provided for processing of large samples which do not fit in standard size histology cassettes and which may be labelled using conventional laboratory printing apparatus. The cassette has a box structure with an apertured base and open top face and the internal length to the internal width of the structure is of a ratio from 1.0 to 1.6 and able to receive sample identification information from an automated cassette printing apparatus and a closure for the open upper face of the structure, engageable with the structure to provide a sample enclosure in which the ratio of the width of the sample enclosure to its depth is less than 5:1 and the ratio of the length of the sample enclosure to its depth is less than 6:1.

This invention relates to a cassette assembly, in particular a histology processing cassette assembly suitable for processing a large biological tissue sample which would not fit within the sample compartment of a standard histology processing cassette.

Biological materials for histological examination are processed in large quantities for a wide range of diagnostic purposes. It is essential to ensure that tissue samples remain uniquely identified with the source of the tissue for technical, medical, ethical and legal reasons. Typically, the tissue is obtained from its source, which may be a patient or from a stored sample, the tissue is then placed in a sample pot or vial and typically transported or mailed to a location for tissue processing and, as applicable, subsequent storage. Throughout the process from taking the sample to sample storage, information about the tissue sample must remain associated with the sample so as to be able to uniquely identify the sample and its source at any point in the process. Typically, a large number of samples, for example 50 or more are processed together. Sample processing cassettes are accordingly marked with a unique identifier. Whilst the identifier may be applied manually, this risks mis-transcription and is labour intensive. Typically, the unique identifier is applied to a cassette by printing using an automated printing process and apparatus. An automated process also allows the unique identifier to be linked to data records of the sample stored in a laboratory information system (LIS).

Known cassettes typically have a uniform “standard” size of about 8 to 32 mm×25 to 28 mm×5 to 10 mm. Larger cassettes, for larger samples are also known and typically have internal dimensions of around 50 to 55 by 65 to 80 by 12 to 17 mm. Cassettes having a similar length and width to a larger size histological cassette but a depth similar to a standard size cassette, preferably to 55 by 65 to 80 by 6 to 9 mmmm, are also known as disclosed in EP-A-2851672.

Cassettes for processing biological tissues typically comprise an open-topped box with a perforated bottom wall. The box may have a perforated top cover which is moveable relative to the box such as a hinged lid or removable. The cassette typically has three vertical side walls and the fourth, side wall, on the front side of the cassette is typically sloping and includes an area for labelling the cassette. Labelling the cassette links the sample in the cassette to its source via a record, which may be kept manually or electronically. Processing cassettes may define one cavity and process one sample at a time or may have multiple cavities to allow processing of multiple samples. Processing cassettes are typically constructed of plastics material and the perforations are made in the plastic material which forms the bottom wall and, where employed, the plastics material forming the lid. In other embodiments, a fine mesh may be employed in the base and or lid to allow passage of fluids therethrough while the sample is being prepared or embedded. The perforations of the cassette are typically from 1 to 3 mm in diameter. Known processing cassettes are described for example in GB 1230913 and U.S. Pat. No. 3,674,396.

Cassettes typically are of a standard size so as to be compatible with laboratory printers. Most modern laboratories have at least one cassette printer for on-demand production of cassettes printed with a unique identifier, for example human readable text and a 2nd 2D barcode identifier to eliminate transcription errors and ensure reliable tracking or maintain a “chain of custody” for patient specimens. Whilst the majority of samples fit within a standard size cassette, certain samples, for example, larger tumours, animal specimens and whole tissues such as eyes, are too large for the standard sized cassette chamber and so require larger cassettes.

However, the vast majority of cassette printers are designed to print standard size cassettes and are not able to print large size cassettes. A limited range of printers are available to print cassettes which are deeper than standard size cassettes. Automated cassette printers are costly, for example upwards of £10,000 per unit, which presents a significant investment for a laboratory and is cost prohibitive for a laboratory to purchase to specifically print on deeper depth cassettes which may only be used for a very small proportion of the laboratory workload. In addition, additional printers for very limited use occupy space and will also require integration with an LIS system, further rendering such printers for occasional use uneconomic. Laboratories may have to resort to labelling such larger cassettes manually with the attendant risks.

We have now devised a novel histology processing cassette assembly which enables larger biological samples to be processed and a unique sample identifier information to be automatically printed on the cassette assembly by providing a structure and a closure which such that the cassette assembly provides a sample compartment which is deeper than the depth of a conventional histology the cassette and is printable with sample information.

In a first aspect, the invention provides a histology processing cassette assembly comprising:
i) a structure having two side walls, a back wall and a front wall defining an upper face at the top of the walls and a lower face at the bottom of the walls, the structure being configured to receive sample identification information from an automated cassette printing apparatus; and
ii) a closure engageable with the structure whereby the structure and closure together or the closure define a sample enclosure having an apertured bottom face and an apertured top face;
wherein the ratio of the internal length to the internal width of the sample enclosure is from 1.0 to 1.6 and the ratio of the width of the enclosure to its depth is less than 5:1 and the ratio of the length of the enclosure to its depth is less than 6:1.

The closure may engage with the structure at any location, for example at or above the top of the walls of the structure, at or below the bottom of the same walls or at any point between the top and the bottom of the walls. Preferably, the closure engages with the structure at or above the top of the walls of the structure.

Suitably, the ratio of the internal length to the internal width of the structure is from 1.0 to 1.3, preferably 1.1 to 1.25.

Preferably the ratio of the internal length to the internal width of the sample enclosure is 1.0 to 1.4 and more preferably 1.1 to 1.3. Preferably, the ratio of the width of the enclosure to its depth is from 4:1 to less than 3:1, more preferably, from 3:1 to 1.5:1. Preferably, the ratio of the length of the enclosure to its depth is less than 5:1, more preferably 5:1 to 2:1.

Suitably, the structure comprises two side walls, a back wall, a front wall further and an apertured bottom face and the closure comprises closure walls and a closure lid comprising apertures, the closure being dimensioned to fit in register with the walls of the structure and the closure and the structure being securable together whereby the walls and bottom face of the structure and the closure walls and closure lid define the sample compartment.

In another embodiment, the structure comprises two side walls, a back wall and a front wall and has an open bottom face and an open top face. The closure comprises a box having side walls, a bottom surface comprising apertures and a lid comprising apertures to cover the top surface which together define the sample enclosure. The closure may be configured to fit on top of the walls of the structure, below the walls of the structure or may be located within the walls of the structure with a part of the closure extending above the structure and/or below the structure. In one embodiment, the bottom face of the closure is flush with the bottom of the walls of the structure such that the closure is an insert in the structure.

The closure is suitably dimensioned to fit in register with the walls of the structure or slidably within the walls of the structure. The closure and the structure are suitably secured together to provide the cassette assembly. The structure may be printed, for example with a unique identifier including or information relating to the sample to be processed, in automated printing apparatus and the closure may be engaged with the printed structure to provide an appropriately labelled cassette assembly. The closure may also carry information, for example a unique identifier including or information relating to the sample to be processed.

The closure suitably comprises side walls and an apertured top face. The apertured top face may be integral with the walls or comprise a lid with apertures which is separate from the closure walls and engagable with the closure walls. Where the closure walls and lid are integral, the sample is placed in the structure on the apertured bottom face and the closure is engaged with the structure thereby to enclose the sample in the sample enclosure.

In an alternative embodiment, the closure may comprise a collar and a separate lid wherein the collar comprises four closure walls and is configured to securably engage with the structure and the lid is engagable with the collar. Suitably, the closure lid and closure walls comprise complementary engagement means. The lid of the closure may be openable when engaged with the closure walls.

The closure may comprise a skirt around part or the whole of the bottom edge of the walls configured to engage with the periphery of the top edge of the walls of the structure to hold the closure and structure in register. Where applicable, the collar and/or lid of the closure may comprise a skirt to enable alignment in register between the collar and structure and/or collar and lid. The collar may comprise a skirt at the bottom and or top of the collar walls. The structure may comprise a skirt or other guidance means, suitably at the periphery of the top edge of the walls for engagement with the closure or collar. The skirt may also reduce the risk of the sample or a part thereof being lost from the sample enclosure.

The top face and/or the bottom face of the sample enclosure are transmissible to processing fluids and/or radiation. The top face of the and/or the bottom face of the sample enclosure may comprise any arrangement through which processing fluids and/or radiation may pass and preferably comprises a wall, for example a rigid plastic wall, having apertures formed therein, or a covering, for example a mesh covering or a flexible plastics covering having apertures formed therein, transmissible to histology processing fluids. The mesh may be a flexible material or may be a rigid plastics portion, preferably formed by injection moulding. The apertures may be of any suitable shape, for example, circular, hexagon, and square. The apertures in the top and/or bottom face may be arranged in any pattern, preferably a regular pattern presenting an array of apertures to maximise transmissibility of processing fluids.

The structure suitably comprises three vertical side walls and a fourth, sloping, side wall, on the front side of the structure. The structure suitably comprises an area for application of the unique identifier, preferably the sloping wall.

Suitably, the external size, shape and configuration of the structure is in the same or a substantially similar form to a known histology processing cassette. The structure may comprise locating means such that the closure upon location on or in the structure, is held in a fixed relationship to the structure such that the cassette assembly is readily handleable. The locating means may comprise a peripheral lip on the side walls such that the closure rests on the lip upon engagement with the structure.

The cassette assembly is suitably constructed of rigid plastics material. Suitably, one or more and preferably each of the structure, the closure, apertured faces and collar are formed by injection moulding.

Histology cassettes are generally of a “standard size” as it is required to fit in other apparatus, for example fit standard specimen holders of microtomes and in printing equipment, employed to label each cassette with information typically relating to the sample in the cassette for example, the patient from whom the sample has been taken. Minor variations in size may occur, dependent for example upon the wall thickness of the box.

The cassette assembly of the invention is particularly suitable for processing samples which have a standard width and length and a greater depth than a standard size cassette. Preferably, the structure has internal dimensions of 28 to 32 mm×25 to 28 mm×5 to 8 mm, similar to the dimensions of a “standard size” histology cassette. The closure suitably extends above and or below the structure such that the depth of the sample enclosure is greater than the depth of a standard size histology cassette.

Certain samples, for example prostate samples are longer or wider than the standard size cassette and require a cassette having a greater width and/or length than a standard size cassette, for example internal dimensions of around 50 to 55 by 65 to 80 by 10 to 17 mm. The structure may have a similar length and width to a larger size histological cassette but a depth similar to a standard size cassette, preferably 55 by 65 to 80 by 5 to 9 mmmm, as disclosed in EP-A-2851672.

Suitably, the sample enclosure has a length and a width the same as a standard histology cassette and a depth about double that of a standard histology cassette, preferably internal dimensions of 28 to 32 mm×25 to 28 mm×9 to 20 mm, for example a depth of 10 to 12 mm.

The structure may comprise an aperture passing vertically through a wall of the structure for receiving a connecting strip in a direction perpendicular to the plane of the structure. A connecting strip allows multiple structures to be held in register when threaded on the connecting strip, facilitating loading of the structures in a magazine in an automated printing apparatus. And avoiding fouling due to adjacent structures being out of register.

The aperture may pass vertically through a side wall, end wall or preferably the front wall of the structure. The aperture allows a connecting strip to be passed therethrough such that a plurality of structure may be threaded onto the strip such that they may be held in register, for example as described in EP-A-2913655.

The structure is suitably adapted to receive a unique identifier preferably applied to a front sloping wall, for ease of observation by a technician in use. The unique identifier is suitably applied automatically, for example using a cassette printer or labelling device. The marking is suitably indelibly applied to the structure for example by printing onto or etching into the material from which the structure is constructed. Automated labelling devices enable rapid throughput and application of a unique identifier or data from electronically stored patient records, for example from a LIS. Devices for applying a unique identifier to a cassette and may be adapted to receive the structure for printing.

Suitably, the structure and the closure comprise complementary engagement means. The complementary engagement means for the closure and the structure and, if present, the lid and closure walls may be the same or different. Preferably, the complementary engagement means for the lid and closure walls and/or for the closure and the structure comprises engagement means located at the front and rear of the cassette assembly.

Suitably, the complementary engagement means comprises a tongue or resilient latch in the structure or closure and a receiving aperture for the tongue or latch in, respectively, the closure or structure. The complementary engagement means may comprise a resilient latch in the structure or closure and a receiving aperture for the latch in, respectively, the closure or structure and also a pivotally rotatable hinge mechanism. Suitably, the pivotally rotatable hinge mechanism comprises a pin in a plane perpendicular to the walls of the structure and a clasp for engagement with and rotation about the pin. The pin may be located on the structure and the clasp located on the closure.

The structure and/or closure may comprise a single compartment or multiple compartments of any desired shape or configuration. Preferably multiple compartments are disposed in a regular arrangement. Examples of multiple compartments include, lengthways compartments extending along the full length of the sample carrier or widthways compartments extending along the full length of the sample carrier or an array of compartments with two in each dimension, for example the sample compartment may comprise multiple compartments across the width of the compartment and multiple compartments across the length of the compartment, for example a 2×2 array, 2×3, 2×4, 2×5, 3×2, 3×3, 3×4, 3×5 array depending on the type and size of samples to be analysed. The compartments suitably have internal divisions for example partitioning walls. The partitioning walls may extend along the length and/or breadth of the structure and/or closure. Suitably, any partitioning walls extend from the bottom face to the top face of the sample enclosure to aid sample isolation.

In another aspect, the invention provides a method of providing a labelled histology processing cassette assembly containing a large biological tissue sample during preparation for analysis comprising:
i) providing a histology processing cassette assembly according to any aspect or embodiment of the invention as described herein;
ii) placing the closure in register with and engaging the structure to define a sample compartment which contains the sample;
iii) applying information to the cassette assembly, preferably the structure, especially the front wall of the structure, using automated cassette printing apparatus before or after step ii);
iv) placing the said sample in the sample compartment and treating the sample by contacting it with a processing solution; and
v) contacting the sample with molten paraffin and cooling the sample in molten paraffin so the sample is embedded in solidified paraffin for further processing.

The present invention is further described by way of example only with reference to the accompanying drawings, in which:

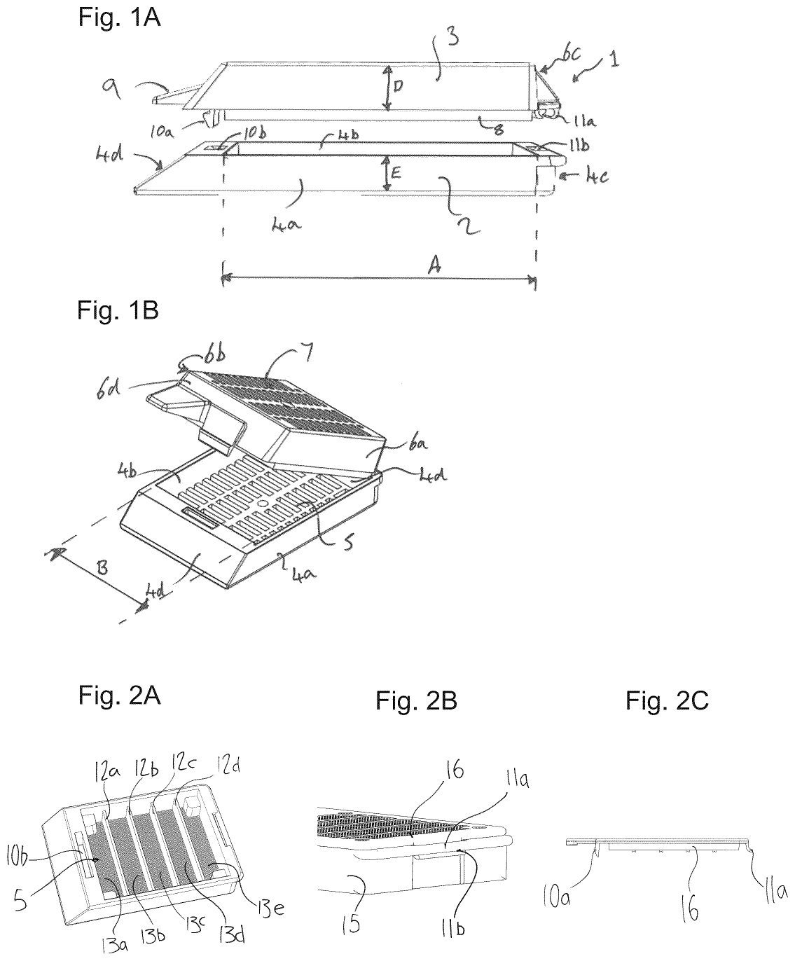

FIGS. 1A and 1B respectively show a side elevation and a perspective view of cassette assembly according to the invention;

FIGS. 2A to 2C shows a plan view, perspective view and side elevation respectively of component parts of a cassette assembly according to the invention;

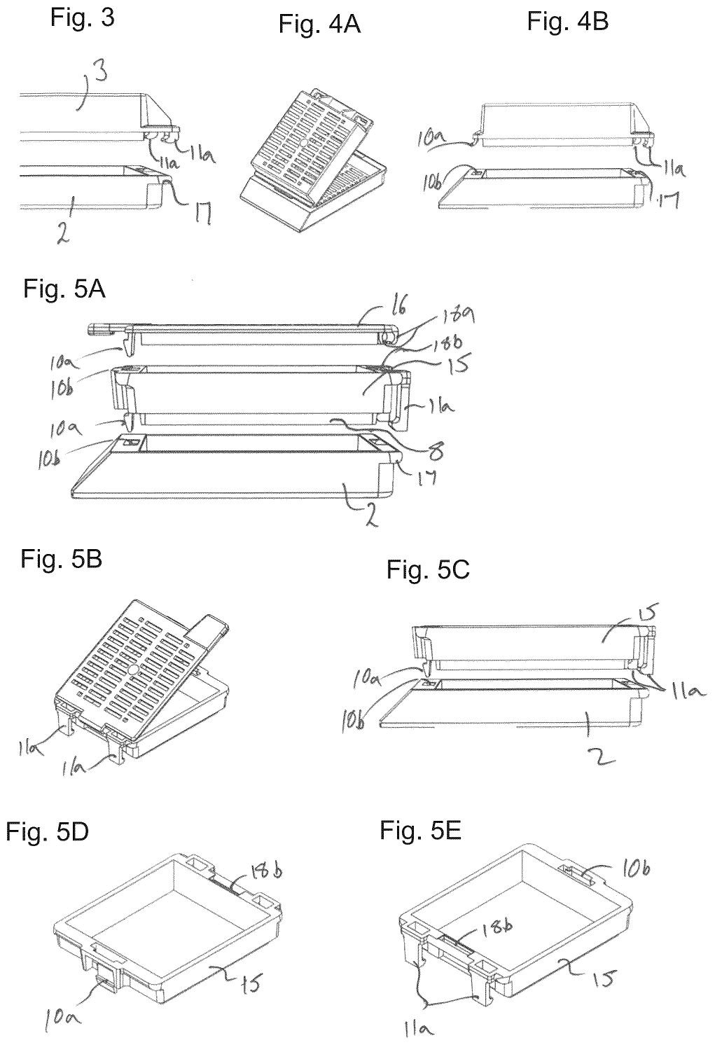

FIG. 3 shows in part a side elevation of components of the cassette assembly according to the invention;

FIGS. 4A and 4B show respectively a perspective and side view of a cassette according to the invention;

FIGS. 5A to 5E show a perspective and side views of a cassette according to the invention in which the closure is a collar and a lid;

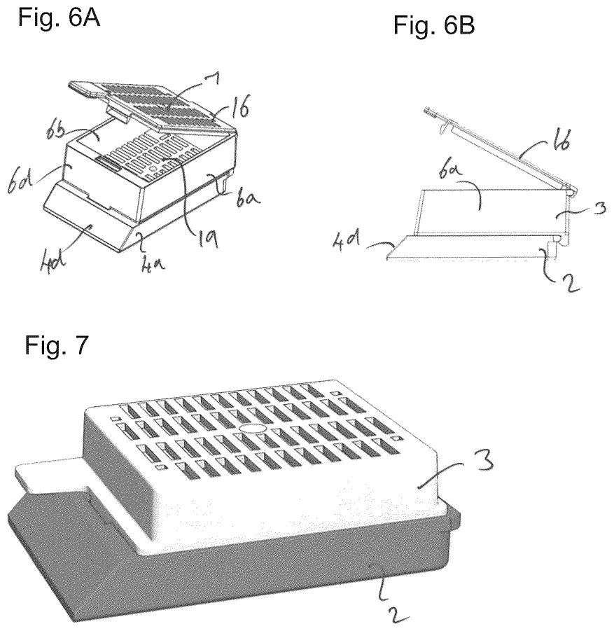

FIGS. 6A and 6B show respectively a perspective and side view of a cassette according to the invention in which the sample enclosure is contained wholly within the closure;

FIG. 7 shows a perspective view of the cassette according to the invention; and

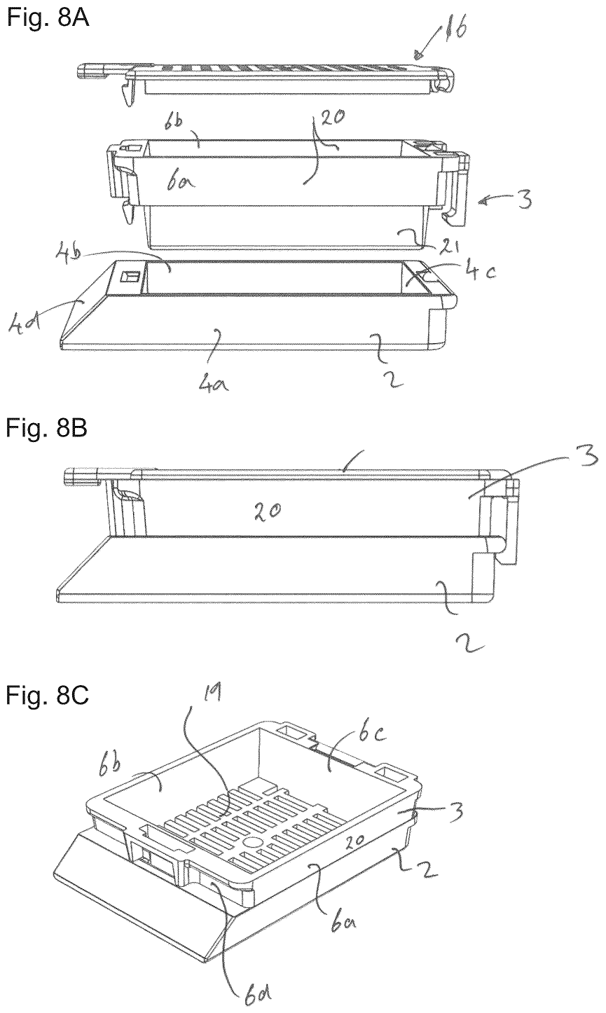

FIGS. 8A to 8C show side elevations and a perspective view respectively of a cassette according to the invention in which the sample enclosure is contained wholly within the closure and the closure is located in part within the structure.

FIGS. 1A and 1B show a cassette assembly 1 having a structure 2 and a closure 3. The structure has two side walls 4a, 4b, a rear wall 4c and a front sloping wall 4d upon which information may be printed in automated histology printing apparatus which, typically, are configured to receive histology cassettes of a standard size. The structure has an apertured bottom face 5. The closure 3 has two side walls 6a, 6b, a rear wall 6c and a front wall 6d and an apertured top face 7. The closure also has a skirt 8 around the bottom edge of the closure 3 which sits inside the top edge of the walls 4a-4d of the structure. The closure has a lug 9 for opening and closing the cassette assembly.

The structure and closure have complementary engagement means 10a, 10b at the front of the cassette assembly and complementary engagement means 11a, 11b at the rear of the cassette assembly. The complementary engagement means may be of any suitable form and a latch 10a and a recess 10b are shown and a clasp 11a and a bar or pin 11b around which the clasp 11a may rotate to provide a pivoting or hinged arrangement, whereby the closure may be rotated relative to the structure to close and open the cassette assembly.

The sample enclosure has dimensions length A×width B×depth C with depth C being the sum of the depth of the closure, shown by arrow D and the depth of the structure, shown by arrow E. The ratio of A:B is from 1.0 to 1.6, preferably 1.0 to 1.4, more preferably 1.1 to 1.3, the ratio of B:C is less than 5:1, preferably from 4:1 to less than 3:1, preferably, from 3:1 to 1.5:1 and the ratio of A:C is less than 6:1, preferably less than 5:1, more preferably 5:1 to 2:1.

FIG. 2A shows an alternative structure 2 to that shown in FIGS. 1A and 1B. The structure has cross walls 12a to 12d to divide the sample enclosure into separate compartments 13a to 13e. The apertured bottom face 5 of the structure is a flexible mesh. FIG. 2B shows a collar 15 for engagement with the structure in FIG. 2A and FIG. 2C shows a lid 16 which, together with the collar 15 forms the closure. The lid 16 has a latch 10a for engagement with a recess in a collar and the bottom wall of the collar has a latch for engagement with a recess 10b in the structure. The complementary engagement means at the rear side of the cassette assembly comprise a tongue 11a on the lid and a bar 11b on the collar and a tongue 11a on the bottom edge of the collar and a bar 11b on the structure. The tongue slides under and engages with the bar. The bar 11b is moulded as a part of the structure.

FIG. 3 shows another complementary engagement means with the closure having two clasps 11a and the structure having a ledge 17 which extends laterally of the rear wall and under which the clasps locate.

FIGS. 4A and 4B show another embodiment of the invention with alternative complementary engagement means which, at the front wall comprise a tongue 10a and recess 10b and, at the rear wall, two clasps 11a and a ledge 17 which extends laterally of the rear wall and under which the clasps locate.

FIG. 5A shows a cassette assembly having a structure 2 and a closure 3 which is composed of a collar 15 and a lid 16. The collar has a skirt 8 and at the rear wall of the collar, two clasps 11a which extend over ledge 17 on the structure which extends laterally of the rear wall and under which the clasps 11a locate. The lid has two clasps 18a which engage with a rail 18b in the collar, shown in FIG. 5B. The complementary engagement means between the lid and collar and the collar and structure both comprise a latch and a recess. FIGS. 5D and 5E show the collar in isolation from different perspectives.

FIG. 6A shows a cassette assembly in which the closure 3 has walls 6a to 6d, an apertured top face 7 in the form of a pivotally mounted lid, engaged with the closure by a clasp and rail arrangement at the rear wall, enabling pivotal movement of the lid. The closure also has an apertured bottom face 19. The sample enclosure is contained wholly within the closure and defined by walls 6a to 6d, bottom face 19 and lid 16. The depth of the closure is greater than the depth of a standard cassette and suitably at least The structure, has walls 4a to 4d and an open top face and open bottom face (not shown). The closure does not need to include a skirt as the sample enclosure is contained wholly within the closure.

FIG. 7 shows a cassette assembly according to the invention and as shown in FIGS. 1A and 1B.

FIG. 8A shows the component parts of a cassette assembly including a structure 2, a closure 3 including lid 16. The closure has a depth which is greater than the depth of a standard cassette and includes an apertured bottom face 19. The sample enclosure is contained wholly within the closure and defined by walls 6a to 6d, bottom face 19 and lid 16. The depth of the closure is greater than the depth of a standard cassette and suitably at least twice the depth of a standard cassette. The structure, has walls 4a to 4d and an open top face and open bottom face (not shown). The walls 6a to 6d of the closure have an upper part 20 and a lower part 21 with the lower part being dimensioned so as to fit within the walls of the structure 2. The bottom face of the closure is flush with the bottom edge of the structure walls 4a to 4d.

FIG. 8B shows the closure located in the structure with the clasps of the closure engaged with the ledge extending from the rear wall of the structure. FIG. 8C sows the apertured bottom face of the closure.

What is claimed is:

1. A histology processing cassette assembly comprising:
i) a structure having two side walls, a back wall and a front wall defining an upper face at the top of the walls and a lower face at the bottom of the walls wherein a ratio of the internal length to the internal width of the structure is from 1.0 to 1.6, the structure being configured to receive sample identification information from an automated cassette printing apparatus; and
ii) a closure engageable with the structure above the top of the walls or below the bottom of the walls whereby the structure and closure together or the closure define a sample enclosure having an apertured bottom face and an apertured top face wherein a ratio of the width of the sample enclosure to its depth is less than 5:1 and a ratio of the length of the sample enclosure to its depth is less than 6:1.

2. A histology processing cassette assembly according to claim 1 wherein the said structure comprising two side walls, a back wall and a front wall defines an open bottom face and an open top face and the closure comprises a box having side walls, a bottom surface comprising apertures and a lid comprising apertures to cover the top surface which together define a sample compartment, the closure being dimensioned to fit in register with the walls of the structure and the closure and structure being securable together.

3. A histology processing cassette assembly according to claim 1 wherein the said structure comprising two side walls, a back wall and a front wall further comprises an apertured bottom face and the closure comprises closure walls and a closure lid comprising apertures, the closure being dimensioned to fit in register with the walls of the structure and the closure and the structure being securable together whereby the walls and bottom face of the structure and the closure walls and closure lid define the sample compartment.

4. A histology processing cassette assembly according to claim 3 wherein the closure walls and lid are integral.

5. A histology processing cassette assembly according to claim 3 wherein the closure walls and lid are separate from the lid and the lid and closure walls are securable together.

6. A histology processing cassette assembly according to claim 5 wherein the closure lid and closure walls comprise complementary engagement means.

7. A histology processing cassette assembly according to claim 1 wherein the structure and the closure comprise complementary engagement means.

8. A histology processing cassette assembly according to claim 6 wherein the complementary engagement means comprises engagement means located at the front and rear of the cassette.

9. A histology processing cassette assembly according to claim 6 wherein the complementary engagement means comprises a tongue or resilient latch in the structure or closure and a receiving aperture for the tongue or latch in, respectively, the closure or structure.

10. A histology processing cassette assembly according to claim 6 wherein the wherein the complementary engagement means comprises i) a resilient latch in the structure or closure and a receiving aperture for the latch in, respectively, the closure or structure and ii) a pivotally rotatable hinge mechanism.

11. A histology processing cassette assembly according to claim 10 wherein the pivotally rotatable hinge mechanism comprises a pin in a plane perpendicular to the walls of the structure and a clasp for engagement with and rotation about the pin.

12. A histology processing cassette assembly according to claim 11 wherein the pin is located in the structure and the clasp is located on the closure.

13. A histology processing cassette assembly according to claim 1 wherein the ratio of the width of the enclosure to its depth is less than 3:1 and the ratio of the length of the enclosure to its depth is less than 3:1.

14. A histology processing cassette assembly according to claim 1 wherein the structure and closure have:
i) a length of 28 to 32 mm and a width of 25 to 28 mm and the sample enclosure has a depth of greater than 5 mm; or
ii) a length of 65 to 80 mm, and a width of 50 to 55 and the sample enclosure has a depth of greater than 10 mm.

15. A method of providing a labelled histology processing cassette assembly containing a large biological tissue sample during preparation for analysis comprising:
i) providing a histology processing cassette assembly according to claim 1;
ii) placing the closure in register with and engaging the structure to define a sample compartment which contains the sample;
iii) applying information to the cassette assembly, preferably the structure, especially the front wall of the structure, using automated cassette printing apparatus before or after step ii);
iv) placing the said sample in the sample compartment and treating the sample by contacting it with a processing solution; and
contacting the sample with molten paraffin and cooling the sample in molten paraffin so the sample is embedded in solidified paraffin for further processing.
